(19) United States
(12) Patent Application Publication
(10) Pub. No.: US 2025/0309635 A1
(43) Pub. Date: Oct. 2, 2025

(54) ELECTRONIC POWER DISTRIBUTOR ARRANGEMENT AND METHOD FOR OPERATING SUCH A POWER DISTRIBUTOR ARRANGEMENT

(71) Applicant: Lisa Dräxlmaier GmbH, Vilsbiburg (DE)

(72) Inventor: Michael WORTBERG, Dorfen (DE)

(73) Assignee: Lisa Dräxlmaier GmbH, Vilsbiburg (DE)

(21) Appl. No.: 19/090,674

(22) Filed: Mar. 26, 2025

(30) Foreign Application Priority Data
Mar. 28, 2024 (EP) 24167330.0

(51) Int. Cl. H02H 7/22; B60R 16/033; H02H 1/00

(52) U.S. Cl. CPC H02H 7/22; B60R 16/033; H02H 1/0007; H02H 1/0092

(57) ABSTRACT

An electronic power distributor arrangement for a vehicle on-board network having at least one load path emanating from an on-board battery, which splits into at least one or more load channels to each of which electrical consumers are connected. Each of the load channels is subdivided into a conductor path applied onto a circuit board, and a supply line leading to the consumer. The load path includes a switch unit that switches off the load path in the event of a thermal overload of one of the supply lines. An evaluation device is assigned with the switch unit, and the evaluation device is to determine a thermal overload of one of the supply lines based on the conductor path temperatures of the conductor paths.

### CROSS-REFERENCE TO RELATED APPLICATIONS

This application claims priority to and the benefit of European Patent Application No. 24167330.0, filed Mar. 28, 2024. The disclosure of the above application is incorporated herein by reference.

### FIELD

The present disclosure relates to an electronic power distributor arrangement for a vehicle electrical system, and a method for operating such an electronic power distributor arrangement.

### BACKGROUND

The statements in this section merely provide background information related to the present disclosure and may not constitute prior art.

In a modern vehicle, the 12V distribution in the vehicle electrical system is no longer realized with a power distribution having fuses but rather using an electronic power distributor arrangement. An electronic power distributor arrangement of the type described above includes at least one load path emanating from an on-board battery, which load path splits into at least two load channels that are each guided to electrical consumers. The electronic power distributor arrangement includes switch units that are realized as transistor switches for fault shutdown.

The replacement of a classical power distributor arrangement with fuses by the electronic power distributor arrangement is motivated as follows: a rapid disconnection is desired to occur in case of failure via a fast transistor switch in order to impede the formation of undervoltage reactions on functional safety units (FuSa functions) by the propagation of short-circuit undervoltages of other loads in the electrical system. In addition, the connected lines must be protected against thermal overload by quasi-stationary overload.

The fault shutdown should also be channel-selective in that only the faulty load channel is switched off. It is also desired to inhibit that a superordinate switch element switches off before or with the faulty load channel and thus entire electrical system portions are separated from the supply. Particularly high demands are produced on the fault control in the electrical system with the introduction of a lithium-ion on-board battery, since a fast-switching battery circuit breaker with relatively low shutdown threshold is provided to inhibit a thermal overload.

In the electronic power distributor arrangement known from the prior art, a MOSFET switch can be disposed in each load channel in order to provide a channel-selective electronic protection. The design complexity as well as the manufacturing costs for such a power distributor arrangement are relatively high, since each of the up to 300 fuses in a classical power distributor arrangement of the vehicle must be replaced by an electronic MOSFET switch (eFuse). Each of these MOSFET switches is equipped with a current measurement, current evaluation, and power shutdown.

Conclusions about the temperature of the supply line, which leads to an electric consumer and is connected to the respective load channel, are indirectly drawn via the current measurement. If an exceeding of a current/time characteristic (I²t) adapted to the thermal properties of the line is detected based on the current measurement, then the respective load channel is switched off. Unnecessary shutdowns can occur with the protection based on the current value/time characteristic, since the environmental temperature is not included when the characteristic is applied. Low environmental temperatures would make possible the carrying of high currents without thermally overloading the line. The underlying current measurement is furthermore subject to tolerances, and since the square of the current makes up the time/current characteristic (I²t), correspondingly expanded tolerance bands result. This situation leads to a wide shutdown corridor in the electronic fuse.

### SUMMARY

This section provides a general summary of the disclosure and is not a comprehensive disclosure of its full scope or all of its features.

The present disclosure provides an electronic power distributor arrangement for a vehicle on-board network as well as a method for operating such an electronic power distributor arrangement, which has a simpler design and is more cost effective in comparison to the prior art.

The present disclosure relates to an electronic power distributor arrangement for a vehicle on-board network, in which a load path originating from an on-board battery splits into at least two load channels. Each of these load channels is guided to an electrical consumer. In addition, each of these load channels is subdivided into a conductor path applied onto a circuit board (PCB) and into a supply line, separate from the circuit board, which is connected thereto, in particular via a modular plug, which supply line leads to the respective consumer. The load path includes a switch unit that switches off in the event that one of the supply lines is thermally overloaded. The switch unit can be a transistor switch applied at the circuit board. An evaluation unit is assigned to the switch unit, by means of which a thermal overload of one of the supply lines can be deduced based on the conductor temperatures of the conductor paths applied at the circuit board.

A group of consumers (a group of overall, for example, twenty consumers) is therefore combined according to the present disclosure into a common MOSFET switch (that is, the switch unit). This produces a cost reduction in comparison to individually protecting each of the load channels, since a MOSFET switch for multiple consumers is more economical than, for example, twenty individual MOSFET switches with corresponding current evaluation and current shutdown.

The temperature of a connected supply line can be very efficiently deduced by means of the present disclosure. This is carried out via a matrix temperature measurement at the switch carrier or the circuit board in that the temperatures of the conductor paths mounted there are measured. The temperature of an individual supply line can be directly inferred via a matrix operation that compensates for the mutual cross-effects of the heating of the conductor paths and the MOSFET heat. Since, according to the present disclosure, the temperature of each of the connected supply lines can be deduced directly from the conductor path temperatures, a laborious current measurement can be omitted. The present disclosure thus makes possible a differentiation between the load of all load channels within the permitted load range and the thermal overload of an individual supply line by evaluating a thermal matrix.

A significant cost reduction as well as an increased net current-carrying capacity of a line prior to a d thermal shutdown can therefore be advantageously achieved in comparison to known electronic power distributor arrangements.

It is advantageous with regard to the design of the present disclosure to arrange a modular plug receptacle on the circuit carrier in order to connect conductor paths to their assigned supply lines, in which modular plug receptacle supply lines can be plugged in using terminal-side plug pins and modules can be used depending on the configuration of the vehicle.

The modular plug can be equipped with a variety of plug terminals that can all be used in a vehicle having in particular many functions and consumers. On the other hand, sockets of the modular plug or entire modules of the plug may not be used in the same vehicle type with a smaller configuration package, Thus, identical circuit carriers can be made available for differently configured vehicles. The line-selective overload recognition functions according to the present disclosure function even when supply lines with different cross-sections are connected to the conductor paths.

The switch transistor according to the present disclosure can be configured as high-current MOSFET switch for carrying a load and a circuit for adding the values of the operationally possible and permitted loads of the connected supply lines.

The consumers of the consumer group connected to the power distributor with a temperature-dependent safety shutdown can be consumers with comfort functions, or at least without functions for a vehicle and/or occupant safety. If only QM consumers are supplied in the group, then a sufficiently low probability of a short circuit can be assumed during travel for the comfort availability. However, a short-circuit protection may be relevant in particular in the event of an issue. In the event of the issue, entire consumer groups can be deactivated, and especially without affecting the use. The evaluation device according to the present disclosure can differentiate whether a basic load of many channels or an overload of a single load channel is present, which can lead to the thermal destruction of the connected line of this channel. In principle, the mechanism for detecting the thermal overload of a supply line by means of a temperature sensing of the conductor paths can also be used for safety consumers.

The evaluation device can be technically implemented as follows: The evaluation device for each of the conductor paths applied at the circuit board, which lead from the switch unit to the plug pins, have sensors for determining the conductor path temperatures of each of the conductor paths. Here, each of the conductor paths can be assigned its own temperature sensor.

The evaluation device can additionally include a calculation component that calculates the supply line temperatures based on the conductor path temperatures detected by sensors. The supply line temperatures can be compared in terms of process technology to a temperature threshold value stored in a comparison component connected downstream. The comparison component generates a switch off signal, provided one of the supply line temperatures is greater than the temperature threshold value. In order to reduce the calculation effort in the comparison component, exactly one common temperature threshold value is stored for all supply line temperatures. In the presence of the shutdown signal, the switch unit switches off the load group with the faulty load path.

The evaluation device starts the evaluation process to check the supply lines as to thermal overload as soon as at least one of the conductor path temperatures exceeds an operating point temperature. The operating point temperature is calculated to be lower than the temperature threshold value. The operating point temperature could be, for example, 80° C. The temperature threshold value for standard PVC lines is 105° C. A temperature threshold value would also be achieved if, starting from the stipulated operating point temperature of 80° C., and additional temperature increase of 25° C. is caused by a current load. In addition to a fixed operating point, it is also possible to use a variable operating point. The latter can be produced by measuring the reference temperature at the edge of the PCB removed from the lossy conductor paths and MOSFET switches. The temperature increase delta is then determined by subtracting this reference temperature from the conductor path temperature.

In one example, a vector calculation is carried out in the calculation component of the evaluation unit. For this purpose, a separate, that is, a channel-specific weighting vector, is stored in the evaluation unit for each load channel. During the evaluation process, the temperature increases detected by sensors in the further course of the process, are made available as temperature vector starting at the operating point temperature. Based on the temperature vector and on the channel-specific weighting vectors, the temperature increase (starting at the operating point temperature) is calculated in the calculation component using a scalar vector multiplication for each supply line. The respective supply line temperature can be determined from the sum of the operating point temperature and the temperature increase. The operating point temperature is either fixed as constant or is determined by measuring the temperature at the edge of the circuit board.

A calibration device can additionally be assigned to the switch unit, by means of which a calibration process can be carried out before operating the electronic power distributor arrangement. In the calibration process, the weighting factors are determined once at the conclusion of the development of the circuit board. At the start of the calibration process, the conductor paths and the supply lines connected thereto are electrically loaded in such a way that they are heated together to the operating point temperature (for example, 80° C.). The channel-specific weighting vector is determined for each load channel in the calibration process.

The calibration process can be carried out in a process sequence in which a calibration step takes place in sequence one after the other for each load channel. In the calibration step, the supply line temperature of the respective supply line is increased by a predefined temperature input step starting at the operating point temperature. The temperature input step is converted into a channel-specific step vector. In the calibration device, a matrix component is also provided in which the step responses of the conductor paths determined by sensors for all temperature input steps are recorded in a matrix. Based on the matrix and the step vectors, a calculation component determines the weighting vectors Ga to Gd for an exemplary group of four load channels that are connected with a switch unit.

The temperature input steps are identical for each supply line. In addition, the temperature input step can arise from a difference between the temperature threshold value and the operating point temperature.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The Figures show different views, based on which the design and the operating principle of the electronic power distributor arrangement are illustrated.

FIG. 1 illustrates an electronic power distributor arrangement;

FIG. 2 is a detail view of a switch unit with assigned load channels of the electronic power distributor arrangement according to FIG. 1;

FIG. 3 is a block diagram of an evaluation device;

FIG. 4 illustrates exemplary vector equations for calculating one or

more supply line temperatures;

FIG. 5 illustrates a calibration device;

FIG. 6 illustrates a temperature input step associated with one or

more supply lines;

FIG. 7 illustrates exemplary measured values from one or more temperature sensors; and

FIG. 8 illustrates a matrix equation for calculating a step vector.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

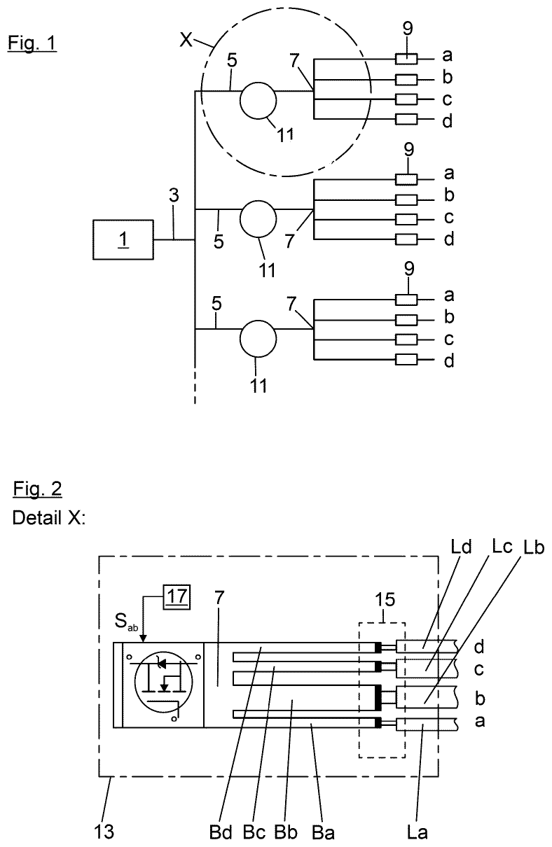

FIGS. 1 and 2 imply an electronic power distributor arrangement including an on-board battery 1, whose main load channel 3 is divided into three load paths 5 connected in parallel to one another. Each of the load paths 5 is, in turn, divided at a bifurcation 7 into a group of in total four load channels a, b, c, d, at each of which a consumer 9 is connected. In FIG. 1, each of the load paths 5 includes a switch unit 11 that is realized as a transistor switch. With the aid of the switch unit 11, a group protection is carried out, in which each switch unit 11 is respectively assigned to, for example, four load channels a, b, c, d. In the practice, 20 load channels (a, b . . . to s) can also be assigned as a group to a switch unit 11.

One of the switch units 11 with the assigned load channels a, b, c, d is implied in detail view in FIG. 2. Accordingly, each of the load channels a, b, c, d is subdivided into a conductor path Ba, Bb, Bc, Bd and a supply line La, Lb, Lc, Ld connected thereto via a modular plug 15; each supply line La, Lb, Lc, Ld leads to consumers 9. Both the transistor switch of the switch unit 11 and the conductor paths Ba, Bb, Bc, Bd are applied at a circuit carrier or a circuit board 13 (that is, a printed circuit board), while the supply lines La, Lb, Lc, Ld extend separately from the circuit board 13. The supply lines La to Ld can be realized as copper lines with different cross sections, for example, with 0.35 m², 0.5 mm² or 6 mm².

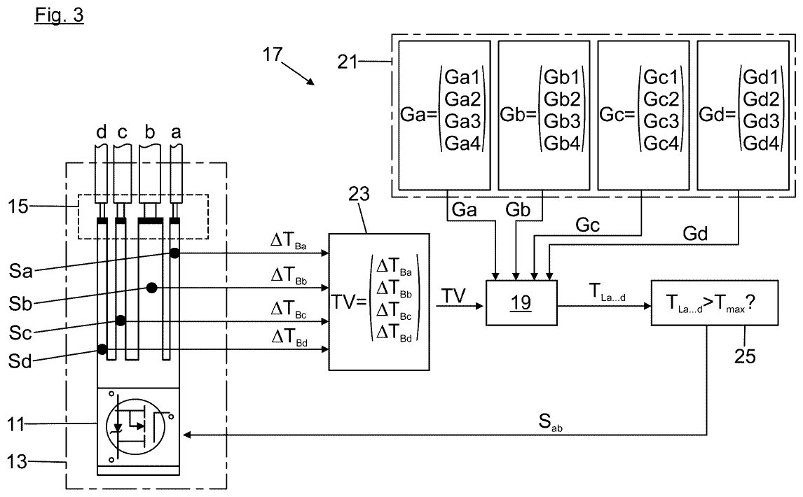

The switch unit 11 arranged in the load path 5 is configured in such a way that the assigned group path 5 is switched off wirelessly in the event of a thermal overload of one of the supply lines La to Ld. For this purpose, the switch unit 11 includes an evaluation unit 17 that generates a shutdown signal S_{ab}, by means of which the switch unit 11 interrupts the group path 5 in the presence of a thermal overload. The software structure of the evaluation device 17 with the corresponding program components is coarsely outlined schematically in this respect in a block circuit diagram of FIG. 3, as is necessary for the understanding of the present disclosure.

Accordingly, the evaluation device 17 includes its own separate temperature sensor Sa to Sd for each conductor path Ba to Bd. The evaluation device 17 starts an evaluation process to check the supply lines La to Ld for thermal overload if at least one of the conductor path temperatures T_{Ba} to T_{Bd} detected by sensors exceeds an operating point temperature T_{AP}, which is, for example, 80° C. As an alternative, the operating point temperature T_{AP} is measured by a temperature sensor at the edge of the circuit board, or a sensor outside the circuit board, that is, outside the distributor arrangement in the respective installation space, is used. The temperature increase delta is then obtained from the difference between the sensor temperature S_{ad} and the operating point temperature T_{AP}:

$$Δ {T}_{Ba} = {T}_{Sa} - {T}_{AP}$$

$$Δ {T}_{Bb} = {T}_{Sb} - {T}_{AP}$$

$$Δ {T}_{Bc} = {T}_{Sc} - {T}_{AP}$$

$$Δ {T}_{Bd} = {T}_{Sd} - {T}_{AP}$$

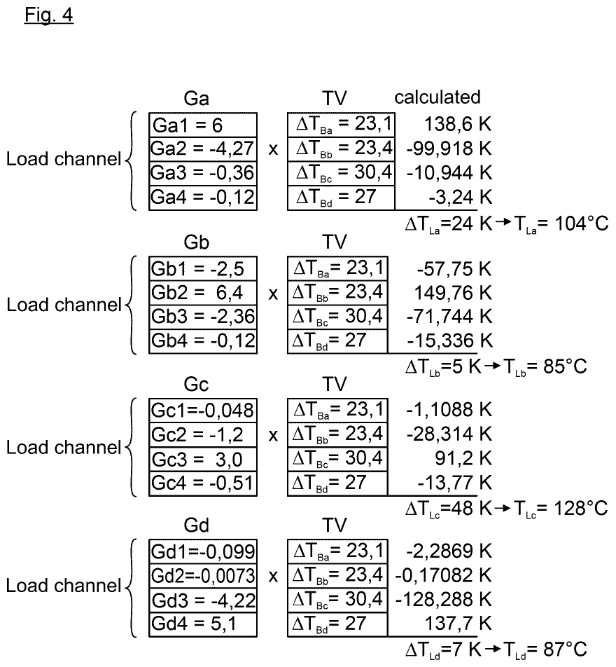

The evaluation device 17 includes a calculation component 19 in which the supply line temperature T_{La} to T_{La} is calculated for each load channel a to d by means of a vector equation (see FIG. 4). In FIG. 2, the calculation component 19 is in signal communication with a database 21 from which a channel-specific weighting vector Ga to Gd can be read into the calculation component 19 for each load channel a to d. In addition, the evaluation device 17 includes a vector program component 23 that condenses the temperature increase ΔT_{Ba} to ΔT_{Bd} detected by sensors in a vector structure (starting from the operating point temperature T_{AP}), that is, it represents it as a temperature vector TV:

$$TV = [ Δ {T}_{Ba} , Δ {T}_{Bb} , Δ {T}_{Bc} , Δ {T}_{Bd} ]$$

The calculation component 19 first determines weighted temperature increases (right column in FIG. 4) from the vector-scalar product of channel-specific weighting vector Ga and temperature vector TV. After adding the operating point temperature T_{AP} is obtained the line temperature T_{La-d}.

The individual line temperatures T_{Lad} are determined according to:

$${T}_{La} = TV * Ga + {T}_{AP}$$

$${T}_{Lb} = TV * Gb + {T}_{AP}$$

$${T}_{Lc} = TV * Gc + {T}_{AP}$$

$${T}_{Ld} = TV * Gd + {T}_{AP}$$

in which TV*Gₓ (xε{a,d}) represents the vector-scalar product of the vector of all measured conductor path temperatures with the respective weighting factor for the respective load channel.

According to FIG. 4, is obtained the following by way of example for the load channel a: The sums of the weighted temperature increases to a temperature increase ΔT_{La}, which is 24K in the supply line La in the calculation component 19. This was obtained with an operating point temperature T_{AP} of 80° C. in a supply line temperature T_{LA} of 104° C.

In FIG. 2, the evaluation device also includes a comparison component 25. In the comparison component 25, each of the supply line temperatures T_{La} to T_{La} calculated in the calculation component 23 can be compared to a temperature threshold value Tₘₐₓ stored in the comparison component 25. If one of the calculated supply line temperatures T_{La} to T_{Ld} is greater than the temperature threshold value Tₘₐₓ, the comparison component 25 generates the shutdown signal S_{ab}. If the shutdown signal S_{ab} is present, the switch unit 11 switches off the load path 5.

For example, the temperature threshold value Tₘₐₓ can be 105° C. Accordingly, the comparison component 25 recognizes that the supply line temperature T_{LC} (128° C. according to FIG. 4) is higher than the temperature threshold value Tₘₐₓ, SO that the comparison component 25 generates the shutdown signal S_{ab}.

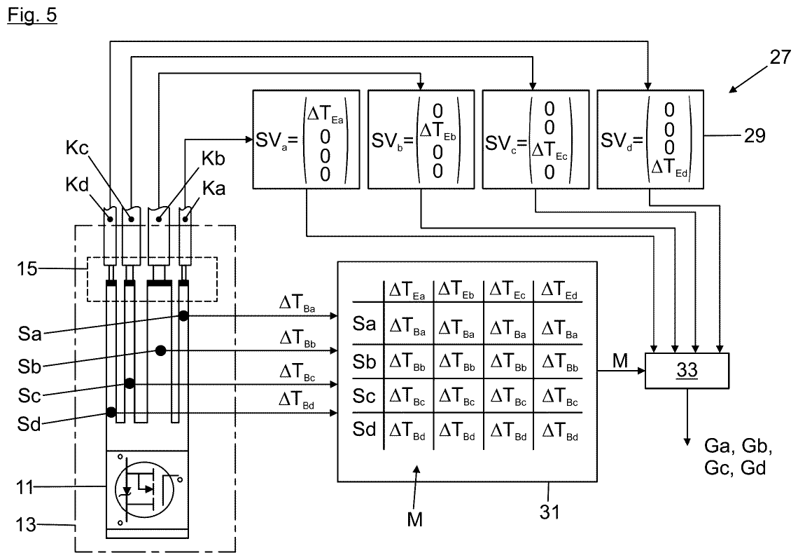

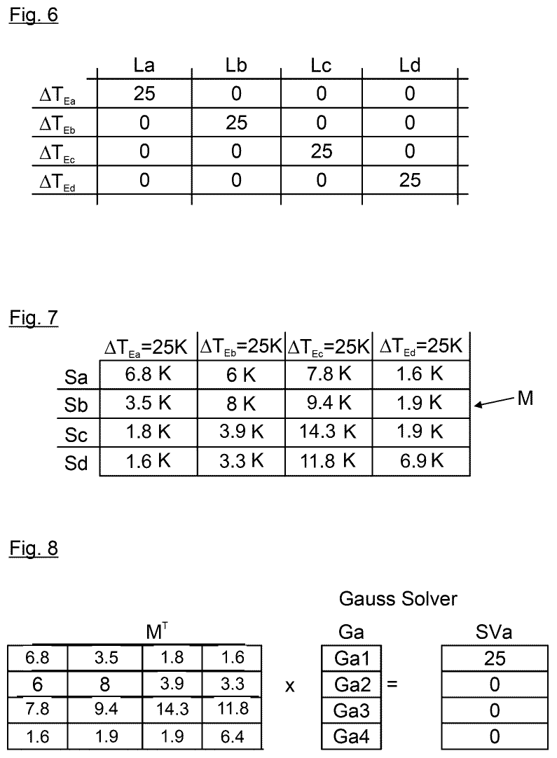

A calibration device 27, with the aid of which a calibration process can be carried out prior to the start of operation or at the end of the development of the circuit board of the power distributor arrangement, is described below based on FIGS. 5 to 8. The assigned weighting vector Ga to Gd is determined in the calibration process for each load channel a to d. Four load paths a-d are assumed; there can also be, for example, up to 20 load channels (a, b . . . to s). In FIG. 5 the calibration device 27 includes calibration sensors Ka to Kd with whose aid a predefined temperature input step ΔT_{Ea} to ΔT_{Ed} can be monitored. In addition, the calibration device 27 includes vector program components 29 that convert each temperature input step ΔT_{Ea} to ΔT_{Ed} into a channel-specific step vector SVa to SVd. In addition, a matrix component 31, in which the step responses ΔT_{Ba} to ΔT_{Bd}, detected by sensors of the conductor paths Ba to Bd can be condensed into a matrix M, is provided in the calibration device 27.

Both the matrix component 31 and the vector program components 29 are in signal connection with a calculation component 33 that calculates the weighting vectors Ga to Gd.

Prior to the start of the calibration process, the load channels a to d are electrically loaded in such a way that they heat up to the operating point temperature T_{AP} (for example, 80° C.). The arrangement can alternatively be heated in a heat cabinet to 80° C. In a further example, the operating point is variable and is measured by means of a temperature measurement at the edge of the circuit board 13 away from the heating conductor paths Ba to Bd, and is included in the calculations. In detail, the calibration process is carried out as follows: The supply line temperature T_{La} to T_{Ld} of the respective supply line La to Ld for each load channel a to d is increased by a load current in sequence one after another starting from a base state of the common operating point temperature T_{AP} by a predefined temperature input step ΔT_{Ea} to ΔT_{Ed} (for example, 25K). From this result the step responses ΔT_{Ba} to ΔT_{Bd} of the conductor paths Ba to Bd, which are detected by sensors, are read into the matrix component M in the matrix component 31. An individual energization is thus performed for each supply path a-d, and the thermal step response of all sensors S_{ad} is recorded as the reaction to the line temperature increase ΔT_{Ea} of the individually energized line.

The temperature input step ΔT_{Ea} to ΔT_{Ed} is typically fixed at 25° C. or 25 Kelvin. The temperature increases ΔT_{Ba} to ΔT_{Bd} on the conductor paths Ba to Bd arise from the following equation: ΔT_{Bx}=Tₛₓ−T_{AP}, that is, from the difference of the measured temperature Tₛₓ; xε{a,d} with the operating point temperature T_{AP}, which is either fixed at typically 80° C., or is determined by means of a reference measurement at the edge of the circuit board 13.

The matrix M is transposed to a matrix MT in the calculation component 33. In addition, the calculation component 33 provides a matrix equation for each load channel a to d. Of these matrix equations is shown the matrix equation for the load channel a by way of example in FIG. 8, from which the weighting vector Ga can be calculated, for example, using the Gauss's method (i.e., Gauss Solver). During the one-time calibration process using the Gauss Solver, the weighting vectors Gₓ (Ga to Gd, x here by way of example a to d) must then be determined in such a way that they each satisfy the matrix equation MT*Gₓ=SVₓ.

The matrix equation shown in FIG. 8 contains a matrix vector product of the transposed matrix MT and the weighting vector Ga on the left side; the channel-specific step vector SVa is found on the right side. The vectors SVₓ correspond thus to
SVa=[25,0,0,0]
SVb=[0,25,0,0]
SVc=[0,0,25,0]
SVd=[0,0,0,25], and specifically
in accordance with the 25° C. stationary heating under the thus set individual loading of the lines La to Ld.

If the switched groups according to FIG. 1 are sufficiently thermally mutually independent, then a (here 4×4) matrix equation can be solved for each group. If all groups with their conductor paths are in strong thermal interaction, then an exact solution is obtained when a (12×12) matrix equation is solved over all conductor paths or load paths (for 3 times 4 load paths).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An electronic power distributor arrangement for a vehicle on-board network, comprising:
at least one load path emanating from an on-board battery, which splits into at least one or more load channels to each of which electrical consumers are connected, each of the at least one or more load channels subdivided into a conductor path applied onto a circuit board and a supply line connected thereto via a plug unit not applied onto the circuit board, leading to the respective one of the electrical consumers, wherein the at least one load path includes a switch unit that switches off the at least one load path in a thermal overload of one of the supply lines and the switch unit is a transistor switch applied onto the circuit board; and
an evaluation device associated with the switch unit configured to determine a thermal overload of one of the supply lines based on conductor path temperatures of each of the conductor paths.

2. The electronic power distributor arrangement of claim 1, wherein the evaluation device includes sensors configured to detect each of the conductor path temperatures for each of the conductor paths.

3. The electronic power distributor arrangement of claim 1, wherein each of the conductor paths is associated with a separate temperature sensor.

4. The electronic power distributor arrangement of claim 1, wherein the evaluation device includes a calculation component that is configured to calculate temperatures of each of the supply lines based on each of the conductor path temperatures.

5. The electronic power distributor arrangement of claim 4, wherein the evaluation device includes a comparison component configured to compare the temperatures of each of the supply lines to a temperature threshold value stored in the comparison component.

6. The electronic power distributor arrangement of claim 5, wherein the comparison component is configured to generate a shutdown signal if one of the temperatures of the supply lines is higher than the temperature threshold value and the switch unit is configured to switch off the at least one load path based on the shutdown signal.

7. The electronic power distributor arrangement of claim 6, wherein the evaluation device is configured to start an evaluation process to check the supply lines for thermal overload if at least one of the conductor path temperatures exceeds an operating point temperature.

8. The electronic power distributor arrangement of claim 7, wherein the operating point temperature is measured lower than the temperature threshold value.

9. The electronic power distributor arrangement of claim 7, wherein a channel-specific weighting vector is stored for each load channel in the evaluation device and, starting from the operating point temperature, temperature increases of each of the conductor paths is represented as a temperature vector in the evaluation process, and the calculation component is configured to calculate the temperature increase for each of the supply lines based on the temperature vector and the channel-specific weighting vectors using a vector-scalar product.

10. The electronic power distributor arrangement of claim 9, wherein the temperature of one of the supply lines is determined from a sum of the operating point temperature and the respective temperature increase.

11. The electronic power distributor arrangement of claim 9, wherein the temperature increases of each of the conductor paths is represented as a vector program component in the evaluation process.

12. The electronic power distributor arrangement of claim 9, wherein a calibration device is associated with the switch unit that is configured to perform a calibration process, and at least one of the channel-specific weighting vector is determined for each load channel in the calibration process and the conductor paths and the supply lines are heated up to the operating point temperature at a start of the calibration process.

13. The electronic power distributor arrangement of claim 12, wherein a calibration step is carried out separately for each load channel in a process sequence in the calibration process, the temperature of the respective supply line is increased by a predefined temperature input step starting from the operating point temperature, a vector program component forms a channel-specific step vector from each of the temperature input steps, the calibration device includes a matrix component, the step responses, which are configured to be detected by sensors, of the conductor paths of all temperature input steps is combined into a matrix, and the calibration device includes a calculation component, and the channel-specific weighting vector is determined for each load channel based on the matrix and the respective channel-specific step vector.

14. A method for operating an electronic power distributor arrangement for a vehicle electrical system according to claim 1.
